(19) United States
(12) Patent Application Publication
(10) Pub. No.: US 2005/0120893 A1
(43) Pub. Date: Jun. 9, 2005

(54) Inking device for gravure printing cylinder

(75) Inventors: Wilfried Kolbe, Gulzow (DE); Bodo Steinmeier, Bielefeld (DE); Andreas Kuckelmann, Ibbenburen (DE); Klaus Schirrich, Bielefeld (DE); Ralf Mulch, Bad Salzuflen (DE)

Correspondence Address: RICHARD M. GOLDBERG, 25 EAST SALEM SREEET, SUITE 419, HACKENSACK, NJ, 07601, US

(73) Assignee: Fischer & Krecke GmbH & Co., Bielefeld (DE)

(21) Appl. No.: 10/985,653

(22) Filed: Nov. 10, 2004

(30) Foreign Application Priority Data
Nov. 14, 2003 (EP) 03 025 991.5

(51) Int. Cl. B41F 31/07

(52) U.S. Cl. 101/155

(57) ABSTRACT

A gravure printing machine having a device (14, 16) for applying ink onto a printing cylinder (10), including an ink supply system (16); wherein a stripping device (14) adapted to strip-off a layer of air that has been entrained by the printing cylinder (10) is arranged at the periphery of the printing cylinder (10) in relation to the ink supply system (16) in such a manner that the printing cylinder (10) will not come into substantial contact with air in a range between the stripping device (14) and the ink supply system.

The invention relates to gravure printing machine comprising a device for applying ink onto a printing cylinder, including an ink supply system.

In gravure printing machines, ink is conventionally applied onto the surface of a rotating printing cylinder. To this end, the printing cylinder may pass through an ink trough. The printing cylinder with ink applied thereon then passes by a doctor unit where the polished surface of the printing cylinder is wiped clean prior to the proper printing process, so that ink will remain only in the engraved printing portions of the printing cylinder surface. Subsequently, the remaining ink is transferred onto a print medium which is pressed against the printing cylinder by means of a pressure roller. When, subsequently, the surface of the printing cylinder is again immersed into the ink trough, ink is applied once again. Instead of being immersed in an ink trough, the printing cylinder may also be supplied with ink from a roller which is immersed into the ink trough.

The known methods and devices for inking a gravure printing cylinder have in common, that the surface of the printing cylinder, after having performed the print operation and before it is inked once again, passes through a region where it is in contact with ambient air. In case of rapidly rotating printing cylinders, this leads to a layer of entrained air being built up on the surface oft the printing cylinder. When, subsequently, the printing cylinder surface is inked again, two undesired effects are observed. First, the air layer impedes the process of wetting the cylinder surface with ink, and, second, part of the air is mixed into the ink. Thus, when the printing cylinder passes through the ink trough, the entrained air layer is directly introduced into the ink in the ink trough, whereas, when the printing cylinder is inked by means of a roller, the entrained air is introduced, together with the ink, into the nip between the inking roller and the printing cylinder. The introduction of air into the ink can lead to foaming of the ink, and air may enter into the engraved portions on the surface of the inked printing cylinder. This will deteriorate the resulting printed image.

These problems become particularly virulent when the print quality and printing speed shall be increased further in modern printing machines.

It is an object of the invention to provide a gravure printing machine having a device for applying ink onto a printing cylinder, wherein the problems indicated above are mitigated.

According the invention, this object is achieved by a gravure printing machine of the type indicated above, in which a stripping device, that is arranged to strip-off the air layer entrained by the cylinder, is associated with the ink supply system in such a manner that the printing cylinder does not come into substantial contact with air in a region between the stripping device and the ink supply system.

Thus, the air entrained by the surface of the printing cylinder is stripped-off from the printing cylinder by means of the stripping device, before the printing cylinder surface is inked by the ink supply system. The surface of the printing cylinder is thereby prevented from coming into substantial contact with air in the region between the stripping device and the ink supply system, and this avoids that a new layer of entrained air is built up. In this way, there is no direct introduction of air into the ink that is applied onto the printing cylinder. The printing cylinder will receive only ink that has not been caused to foam by being mixed with air. Even when the rotary speed and the surface speed of the printing cylinder are increased, which promotes the tendency to entrain an air layer, the process of applying ink onto the surface of the printing cylinder will not be disturbed. The amount of ink being applied can be controlled by active supply of ink to the printing cylinder. As an alternative, the ink may be contained in an ink trough through which the surface of the printing cylinder passes through.

Useful embodiments of the invention are indicated in the dependent claims.

Preferably, the stripping device is arranged immediately upstream of the ink supply system. This is the easiest way to avoid a contact of the printing cylinder surface with air between the instants of passing the stripping device and passing the ink supply system. Moreover, the stripping device may advantageously be integrated with the ink supply system into one construction unit, so that these devices may be set against the printing cylinder together.

Preferably, the stripping device is a doctor blade assembly. The doctor blade may have a construction similar to that of known doctor blades in doctor units and may be set against the printing cylinder in a similar manner. Preferably, the ink supply system is arranged to supply ink onto the printing cylinder along the back side of the doctor blade. Then, the ink may be applied immediately after the entrained air layer has been stripped-off.

In a first embodiment, the ink supply system has an ink applying nozzle. The letter may be supplied with ink from an ink supply passage and may for example have a downwardly directed nozzle opening for creating an ink curtain flowing against the printing cylinder. More particularly, the ink supply nozzle may be arranged to direct the ink onto the back side of the doctor blade of the stripping device without being sputtered. Then, the ink curtain flows along the back side of the doctor blade.

Preferably, the stripping device and the ink supply system are arranged within an angular range of the printing cylinder of less that 90°, preferably less than 60°, behind the pressure roller where the proper printing process takes place. If possible, this angular range should be even smaller. Preferably, the stripping device and the ink supply system are located as close as possible to the pressure roller, so that the range, in which the printing cylinder is in contact with air between the pressure roller and the stripping device is as small as possible. This is not only advantageous for suppressing the build-up of the entrained air layer, but also shortens the time in which the surface of the printing cylinder my run dry.

In another embodiment, the ink supply system comprises a container filled with ink and open towards the printing cylinder, and the printing cylinder comes into contact with the ink in the container. For example, the ink supply system may comprise an upwardly open ink trough into which the printing cylinder immerses.

Preferably, the stripping device is adapted to be set against the printing cylinder in a position below the level of ink in the container. For example, the stripping device may be a doctor blade assembly. In this case, preferably, the doctor blade is capable of being engaged with its edge against the printing cylinder in a condition, where the edge is below the level of ink in the container. By means of the stripping device, the air layer entrained by the printing cylinder is stripped-off, and, immediately thereafter, the printing cylinder is in contact with the ink. In this way, the ink may reliably be applied even at high rotary speed of the printing cylinder, without causing ink that has been mixed with air to be applied onto the printing cylinder. The ink will be mixed with the air stripped-off from the printing cylinder only, if at all, in a limited region upstream of the stripping device. By appropriately designing the stripping device and the container, it can be assured that the air will escape from this region towards the ink surface.

Preferred embodiment examples of the invention will now be explained in conjunction with the drawings, wherein:

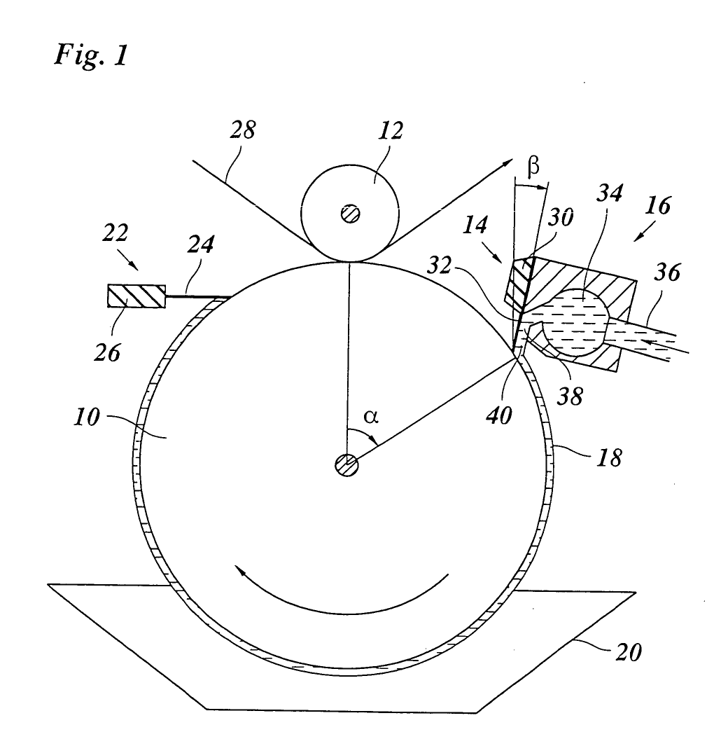

FIG. 1 is a schematic view of a part of a gravure printing machine according to a first embodiment; and

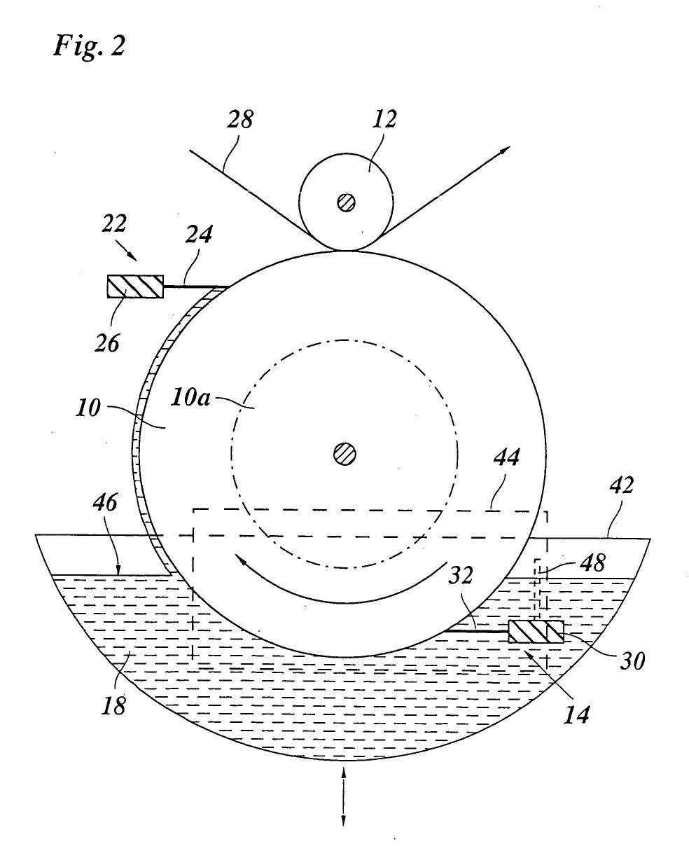

FIG. 2 shows another embodiment.

The gravure printing machine shown in FIG. 1 comprises a printing cylinder 10 and a pressure roller 12 which are rotatably supported in a machine frame. The frame and associated drive and adjusting means have not been shown here, because they are not essential for understanding the invention.

The gravure printing cylinder 10 is in contact with a stripping device 14. At the locus of contact, ink 18 is applied onto the surface of the printing cylinder by means of an ink supply system 16. The printing cylinder 10 rotates in a direction indicated by an arrow and thereby carries along the ink 18 that has been applied to its surface. A surplus of ink 18 may drop into a collecting trough 20 arranged beneath the printing cylinder 10. The printing cylinder is doctored in a doctor unit 22 which, in a known manner, is formed by a doctor blade 24 mounted to a bracket 26. The edge of the doctor blade 24 set against the surface of the printing cylinder 10 removes the ink from the smooth, non-printing surface portions of the printing cylinder 10, so that the ink will only remain in the engraved portions which are to create a printed image on a print medium web 28. The web 28 is pressed against the printing cylinder 10 by means of the pressure roller 12.

Between the pressure roller 12 and the stripping device 14, the gravure printing cylinder 10 passes through an angular range a which, in the example shown, amounts to approximately 60°. Because of the high rotary speed of the gravure printing cylinder 10, its surface velocity may for example be as high as 10 m/s. While the surface of the printing cylinder 10 passes through the angular range α between the pressure roller 12 and the stripping device 14, an entrained air layer is built up on its surface. This layer is stripped-off from the surface of the printing cylinder 10 by means of the stripping device 14 which is formed by a doctor blade assembly having a doctor blade 32 mounted to a bracket 30. Similar to what is known for doctor units, the doctor blade assembly may be fixed to levers with which it may be pivoted against the periphery of the printing cylinder 10, so that the surface thereof is engaged by the edge of the doctor blade 32. In this way, the doctor blade 32 is capable of reliably stripping-off the layer of air that has been entrained by the surface of the printing cylinder 10. The doctor blade 32 is inclined relative to the surface of the printing cylinder 10 in the direction of rotation of the latter.

On the back side of the doctor blade 32, the ink 18 is applied onto the printing cylinder 10 by means of the ink supply system 16. The ink supply system 16 is mounted to the bracket 30 for the stripping device 14. It comprises an ink distributing chamber 34 to which ink is continuously supplied through a supply passage 36. On the downstream side, the ink distributing chamber 34 merges into an ink applying nozzle 38 which, as the ink distributing chamber 34, extends along the doctor blade 32. By means of the ink applying nozzle 38, the ink 18 is guided to the back side of the doctor blade 32 without being sputtered, and the ink then hits the surface of the printing cylinder 10 as an ink curtain. In this way, an introduction of air into the ink 18 can reliably be prevented, even at very high surface speeds of the printing cylinder 10. The ink 18 will therefore form a homogeneous ink layer on the printing cylinder 10. This is promoted by the fact that the ink is supplied as soon as possible after the print operation at the web 28, so that, advantageously, it takes a long time until the doctor unit 22 is reached. Consequently, the angular range a should preferably be small. To this end, the doctor blade 32 may be inclined relative to a vertical line by an angle β towards the ink supply system 16, as in the example shown, so that the ink curtain 40 is located below the back side of the doctor blade 32. Since the bracket 30 is tilted to the right side in the drawing, the edge of the doctor blade 32 can be brought closer to the pressure roller 12.

FIG. 2 shows another embodiment of the gravure printing machine shown in FIG. 1. Here, the ink is applied onto the gravure printing cylinder 10 not by means of an ink applying nozzle, but the surface of the gravure printing cylinder 10 passes through an ink supply system configured as an ink trough 42 filled with ink 18. The stripping device 14 formed by the doctor blade assembly having the doctor blade 32 fixed to the bracket 30 is here arranged inside of the ink trough 42. The stripping device 14 is mounted to a holding structure 44 that is fixed at the ink trough 42 by fixtures permitting quick detachment.

For example, the holding structure 44 may comprise a plate at each end of the stripping device 14, bounding the space above the stripping device 14 in lateral direction (before and behind the plane of the drawing).

The doctor blade 32 is adapted to be set against the periphery of the printing cylinder 10 in such a position that the surface of the printing cylinder is engaged by the edge of the doctor blade 32. The edge of the doctor blade is located below the level 46 of ink in the ink trough 42. The stripping device 14 is arranged on the side of the printing cylinder 10 on which the surface of the latter enters into the ink 18. Thus, the doctor blade 32 is capable of reliably stripping-off a layer of air that has been entrained by the surface of the printing cylinder 10. The air that has been introduced into the ink 18 in this way is located above the stripping device 14 and will rise to the surface of the ink 18. Thus, the ink 18 in the other regions of the ink trough 42 can be prevented from being mixed with air.

In FIG. 2, phantom lines indicate a gravure printing cylinder 10a the periphery of which is significantly smaller than that of the printing cylinder 10. This corresponds to a significantly smaller printing length. The ink trough 42 is height-adjustable, as has been indicated by a double arrow, for being adapted to the size of the printing cylinder. The position of the stripping device 14 relative to the ink trough 42 may be made adjustable by suitably configuring the holding structure 44. Optionally, the holding structure 44 may also be removed from the ink trough 42 and may be fixed thereon in a different position, or it may be moved together with the ink trough 42.

In a modification of the illustrated embodiment, the stripping device 14 may also comprise a separator 48 which has been shown in dashed lines. This separator may for example be a grid or mesh which prevents the air that has been introduced into the ink 18 above the doctor blade 32 from spreading further. As shown, the separator 48 may extend from the surface of the doctor blade assembly to above the ink level or, as an alternative, it may extend from the doctor blade assembly to an edge of the ink trough 42. Optionally, the separator 48 may also be a barrier, which is impenetrable for the ink.

The illustrated embodiments serve only as examples for a printing machine according to the invention. The stripping device 14 may also have a configuration other than a doctor blade assembly, as far as there is provided a member which can be set against the printing cylinder 10 and is capable of reliably stripping-off the entrained air layer. Further, additional equipment may be provided between the stripping device 14 and the ink supply system or between the ink supply system and the doctor unit 22, such as, for example, another ink supply system.

The ink 18 is not limited to printing ink in the proper sense of the word. Instead, the invention is also applicable to other liquids with different viscosities, that are to be applied onto a printing cylinder.

1. Gravure printing machine comprising:
a device for applying ink onto a printing cylinder including an ink supply system,
a stripping device adapted to strip-off a layer of air that has been entrained by the printing cylinder, the stripping device being arranged at a periphery of the printing cylinder in relation to the ink supply system in such a manner that the printing cylinder will not come into substantial contact with air in a range between the stripping device and the ink supply system.

2. Gravure printing machine according to claim 1, wherein the stripping device is arranged immediately upstream of the ink supply system.

3. Gravure printing machine according to claim 1, wherein the stripping device is a doctor blade assembly having a doctor blade.

4. Gravure printing machine according to claim 3, wherein the ink supply system is adapted to apply ink onto the printing cylinder along a back side of the doctor blade.

5. Gravure printing machine according to claim 1, wherein the ink supply system comprises an ink applying nozzle.

6. Gravure printing machine according to claim 4, wherein the ink applying nozzle is arranged to guide the ink to the back side of the doctor blade without the ink being sputtered.

7. Gravure printing machine according to claim 1, wherein that the stripping device and the ink supply system are arranged within an angular range of the printing cylinder of less than 90°, behind a pressure roller, where a printing medium is being printed on.

8. Gravure printing machine according to claim 1, wherein the ink supply system comprises a container that is open towards the printing cylinder and is filled with ink, and the printing cylinder is in contact with the ink in the container.

9. Gravure printing machine according to claim 8, wherein the stripping device is adapted to be set against the printing cylinder in a position below the ink level in the container.

10. Gravure printing machine according to claim 7, wherein the stripping device and the ink supply system are arranged within an angular range of the printing cylinder of less than 60°, behind the pressure roller, where the printing medium is being printed on.
